(19) United States
(12) Patent Application Publication
(10) Pub. No.: US 2026/0109081 A1
(43) Pub. Date: Apr. 23, 2026

(54) FANCY CONCAVE CUTTING GEMSTONE FACETING ATTACHMENT DEVICE

(71) Applicant: Lain Murphy, Brooklyn Heights, OH (US)

(72) Inventor: Lain Murphy, Brooklyn Heights, OH (US)

(21) Appl. No.: 19/291,117

(22) Filed: Aug. 5, 2025

Related U.S. Application Data
(60) Provisional application No. 63/679,316, filed on Aug. 5, 2024.

(51) Int. Cl. B28D 5/02; B28D 5/00

(52) U.S. Cl. CPC B28D 5/022; B28D 5/0076

(57) ABSTRACT

The fancy concave cutting gemstone faceting attachment device is a device that allows concave type faceting of gemstones by means of mounting this device to an existing faceting machine. This may be accomplished utilizing the existing machines drive motors and hardware. This device prevents the need to purchase completely separate concave faceting machines to accomplish the same task of concave faceting. This is preferably a universal machine design allowing this device to mount to many makes of faceting machines in the current marketplace.

### CROSS REFERENCE TO RELATED APPLICATIONS

This application claims priority to and the benefit of the filing date of U.S. Provisional Application No. 63/679,316, filed on Aug. 5, 2024, entitled “Fancy Concave Cutting Gemstone Faceting Attachment Device”, which is hereby incorporated by reference in its entirety.

### FIELD OF THE INVENTION

This patent specification relates to the field of gemstone cutting and processing devices. More specifically, this patent specification relates to a fancy cut concave faceting attachment device that may be used or added to an existing or new faceting machine.

### BACKGROUND OF THE INVENTION

It is desirable to have the capability to concave (inverse cylindrical and other shapes) cut shapes into the surface of stones and gemstones. The basic history in such devices configured for this capability has been to add visual appeal and light reflecting properties to precious cut gemstones primarily. To have the capability to concave cut shapes into the surface of stones and gemstones has required the purchase and use of a separate machine dedicated to this purpose.

Current designs of concave cutting machines are not capable of being added to an existing faceting machine. This limitation creates several unique problematic areas in gemstone cutting accuracy and extensive costs. Therefore, there exists a need for novel devices that provide the capability to concave (inverse cylindrical and other shapes) cut shapes into the surface of stones and gemstones.

### BRIEF SUMMARY OF THE INVENTION

A fancy concave cutting gemstone faceting attachment device is provided. The device adds the capability to concave (inverse cylindrical and other shapes) cut shapes into the surface of stones and gemstones. Consolidating the device to an existing faceting machine circumvents the need for extra faceting machines to achieve the same concave cutting results. Simplicity of the design of the device removes the complexity found in current machines that can concave facet.

Preferably, the device may be for use with a faceting machine having a rotating platen and a main base plate, and the device may include: a Protractor base plate configured to be coupled to the main base plate of the main faceting machine; a protractor swivel base plate movably coupled to the Protractor base plate; an Oscillation cross slide base movably coupled to the protractor swivel base plate so that the Oscillation cross slide base is linearly movable towards and away from the platen; an Oscillation cross slide motor mount plate movably coupled to the Oscillation cross slide base so that it is movable in a direction perpendicular to the linearly movable coupling of the Oscillation cross slide base to the protractor swivel base plate; a motor coupled to the Oscillation cross slide motor mount plate; and a Motor collet chuck coupled to the motor.

The addition of the fancy concave cutting gemstone faceting attachment device to an existing faceting machine allows end users to add concave facets to stones and precious gemstones.

The diversity in angles allowed with this device exceeds any current design and opens the range of capability of concave cuts that can be added to a gemstone or stone.

A unique and novel feature of the oscillation platform is that it may be driven by the main motor on the existing faceting machine the unit is added to.

The addition of this device allows the use of the existing gemstone cutting masts and hardware on existing machines to be used, eliminating the need to purchase extra machines to accomplish the same task.

The addition of this device allows the use of the existing gemstone cutting masts and hardware on existing machines to be used, eliminating the need to purchase extra machines to accomplish the same task.

### BRIEF DESCRIPTION OF THE DRAWINGS

FIG. 1 shows a front perspective view of an example of a fancy concave cutting gemstone faceting attachment device according to various embodiments described herein.

FIG. 2 depicts a rear perspective view of an example of a fancy concave cutting gemstone faceting attachment device according to various embodiments described herein.

FIG. 3 illustrates another front perspective view of an example of a fancy concave cutting gemstone faceting attachment device according to various embodiments described herein.

FIG. 4 shows another front perspective view of an example of a fancy concave cutting gemstone faceting attachment device according to various embodiments described herein.

FIG. 4 depicts a front perspective view of another example of a fancy concave cutting gemstone faceting attachment device according to various embodiments described herein.

FIG. 5 illustrates a side perspective view of another example of a fancy concave cutting gemstone faceting attachment device according to various embodiments described herein.

FIG. 6 shows another front perspective view of another example of a fancy concave cutting gemstone faceting attachment device according to various embodiments described herein.

FIG. 7 depicts another front perspective view of another example of a fancy concave cutting gemstone faceting attachment device according to various embodiments described herein.

FIG. 8 illustrates another front perspective view of another example of a fancy concave cutting gemstone faceting attachment device according to various embodiments described herein.

FIG. 9 shows a front perspective view of a further example of a fancy concave cutting gemstone faceting attachment device according to various embodiments described herein.

FIG. 10 depicts another front perspective view of a further example of a fancy concave cutting gemstone faceting attachment device according to various embodiments described herein.

FIG. 11 illustrates a rear perspective view of a further example of a fancy concave cutting gemstone faceting attachment device according to various embodiments described herein.

FIG. 12 shows a side elevation view of a further example of a fancy concave cutting gemstone faceting attachment device according to various embodiments described herein.

FIG. 13 depicts a top plan view of a further example of a fancy concave cutting gemstone faceting attachment device according to various embodiments described herein.

FIG. 14 illustrates a front elevation view of a further example of a fancy concave cutting gemstone faceting attachment device according to various embodiments described herein.

FIG. 15 shows a rear perspective view of a further example of a fancy concave cutting gemstone faceting attachment device according to various embodiments described herein.

FIG. 16 depicts another front perspective view of a further example of a fancy concave cutting gemstone faceting attachment device according to various embodiments described herein.

### DESCRIPTION OF THE REFERENCED NUMERALS

Protractor base plate 1, preferably with incremental 360 degree graduations
Protractor swivel base plate 2, preferably having 1/10^{TH} degree increment graduations
Oscillation cam, platen mounted 3
Oscillation platform base with linear bearing mount 4
Oscillation cross slide micrometer dial 5
Oscillation cross slide base 6
Oscillation platform linear bearings 7
Oscillation cross slide motor mount plate 8
Oscillation cross slide motor mount plate lock 9
Motor mount brackets 10
Motor 11, preferably electric 24V DC motor
Water catch basin 12, preferably rigid or flexible in construction
Motor collet chuck 13
Cutting mandrel 14, various sizes
Mast hard stop shaft 15
Mast hard stop adjustable locking block 16
Mast hard stop adjustable lock lever 17
Mast hard stop fine tune micrometer head 18
Mast hard stop guide rods 19
Main mast support slide bar 20
Oscillation cam follower bearing 21
Rotating platen (part of main faceting machine) 22
Main mast base with dovetail rail 23
Main mast base locking screw 24
90-Degree motor adaptor plate 25

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

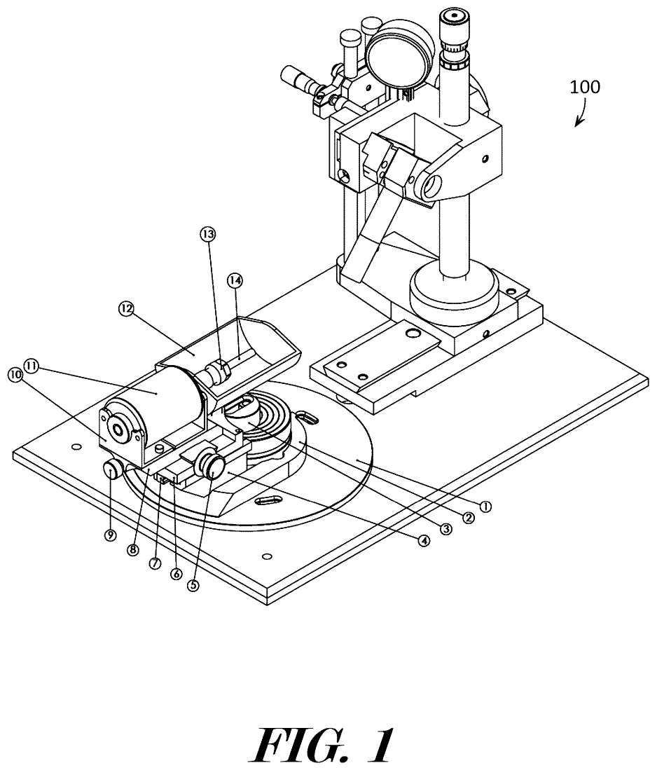

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. may be used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new fancy concave cutting gemstone faceting attachment device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

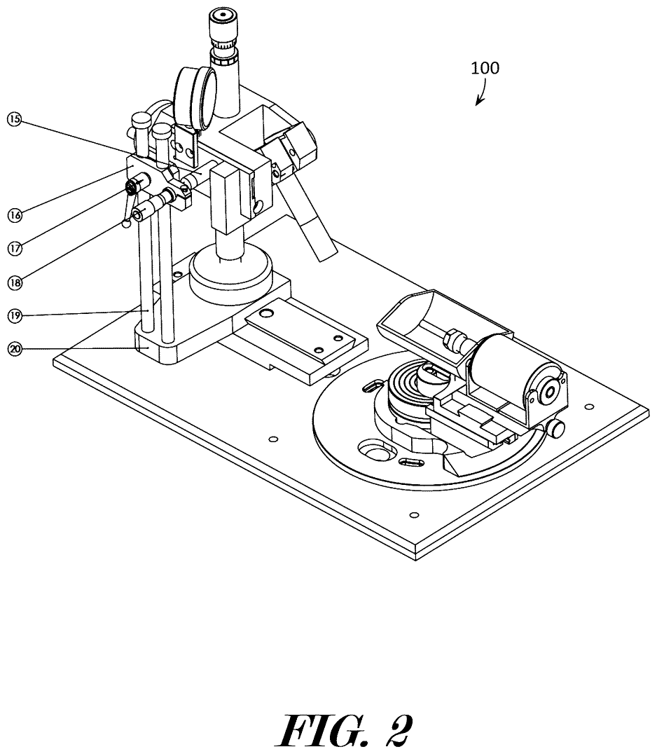

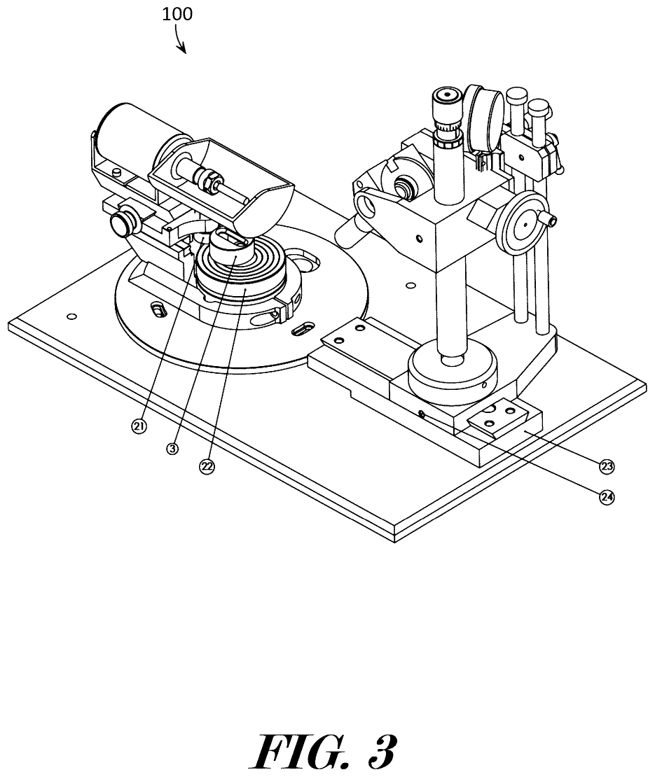

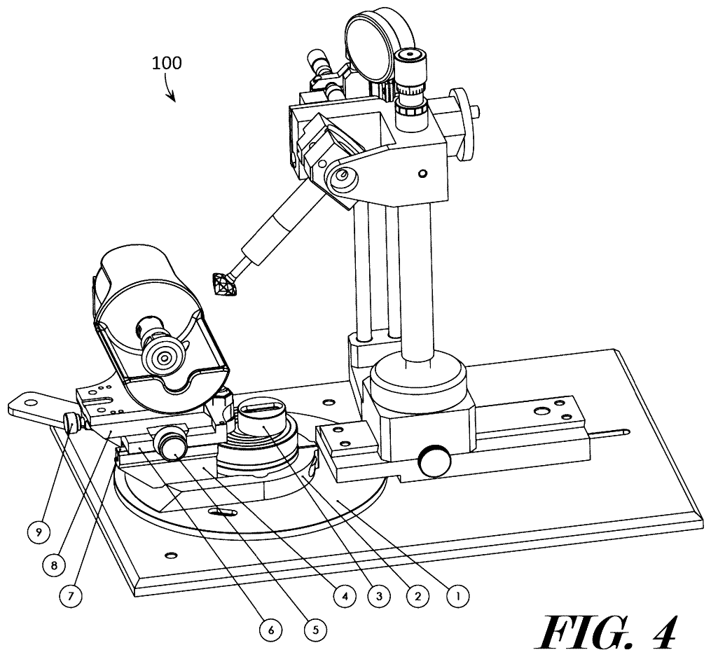

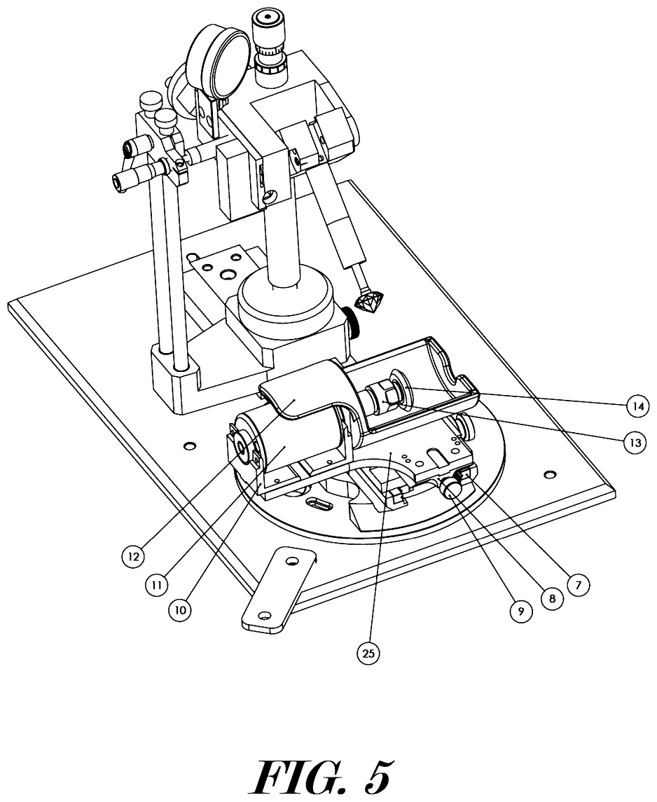

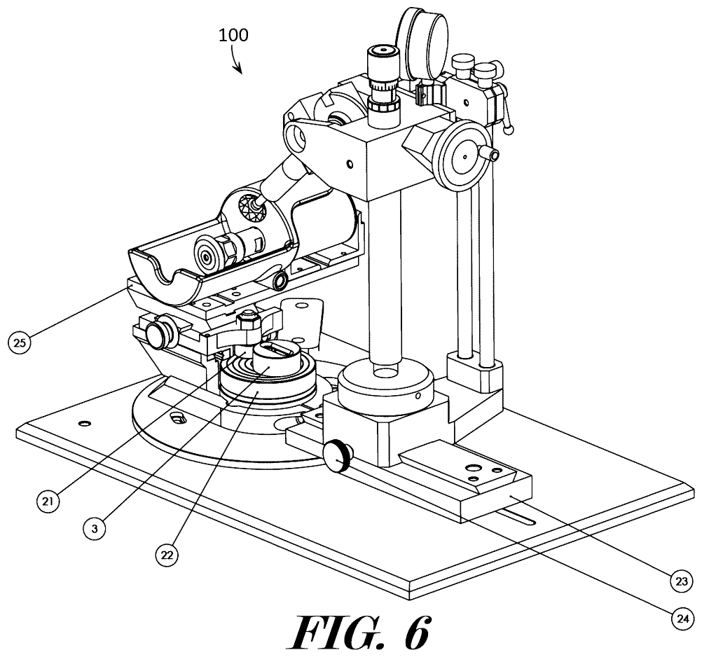

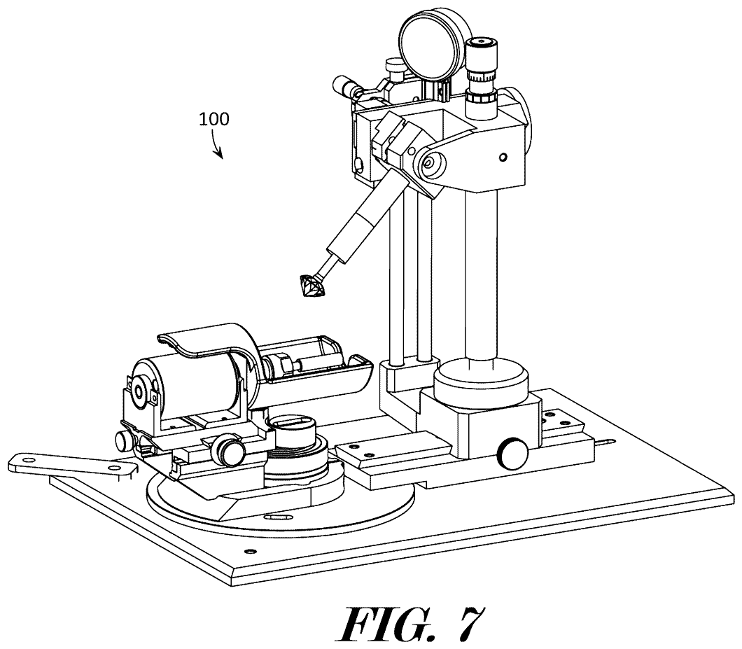

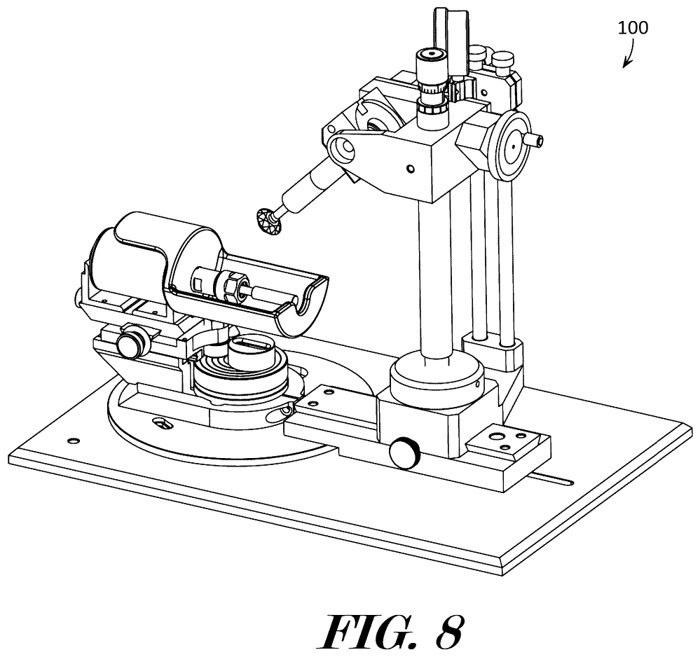

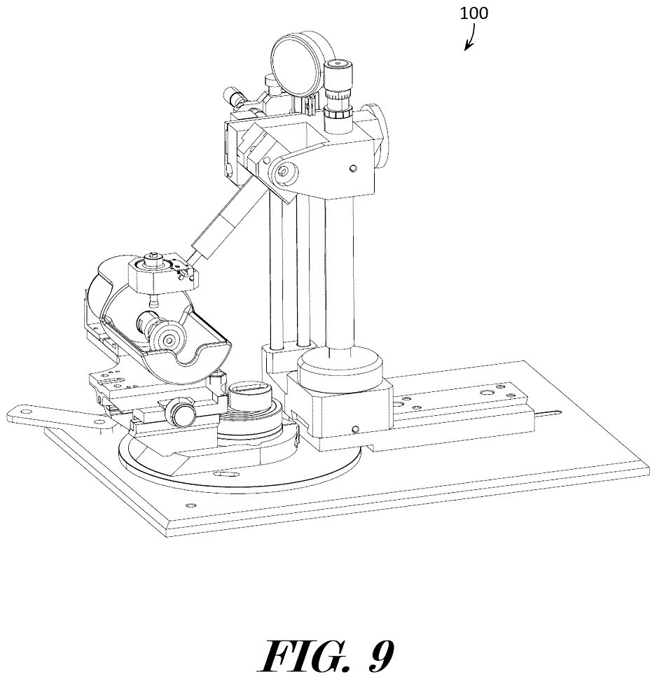

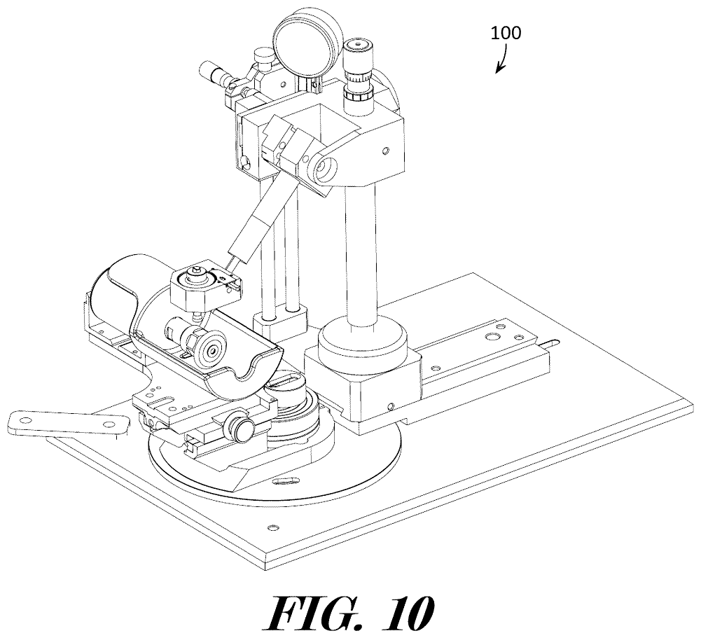

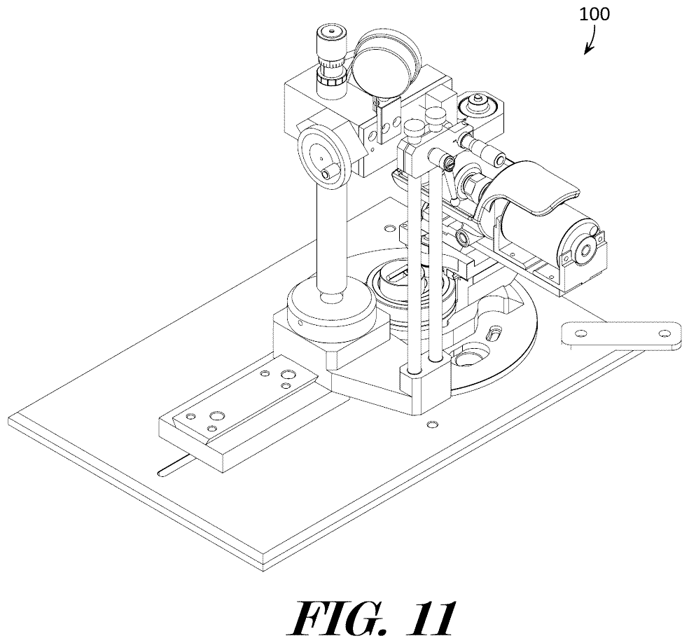

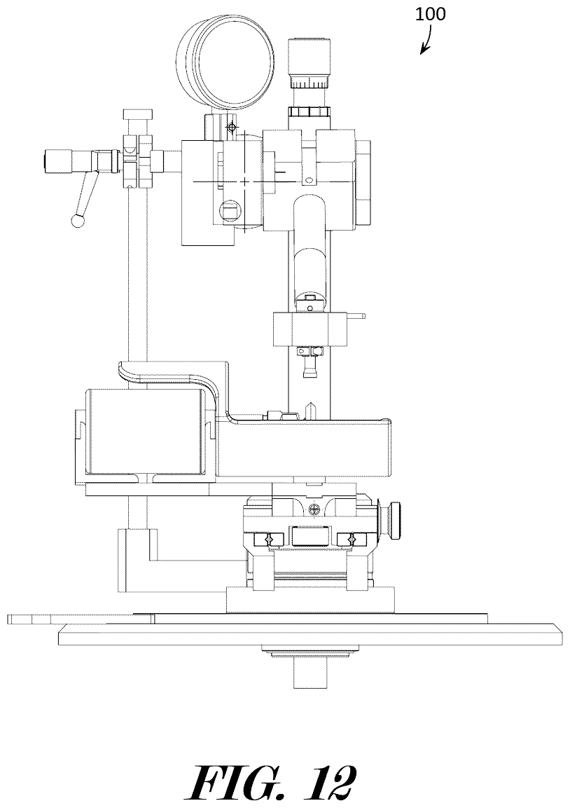

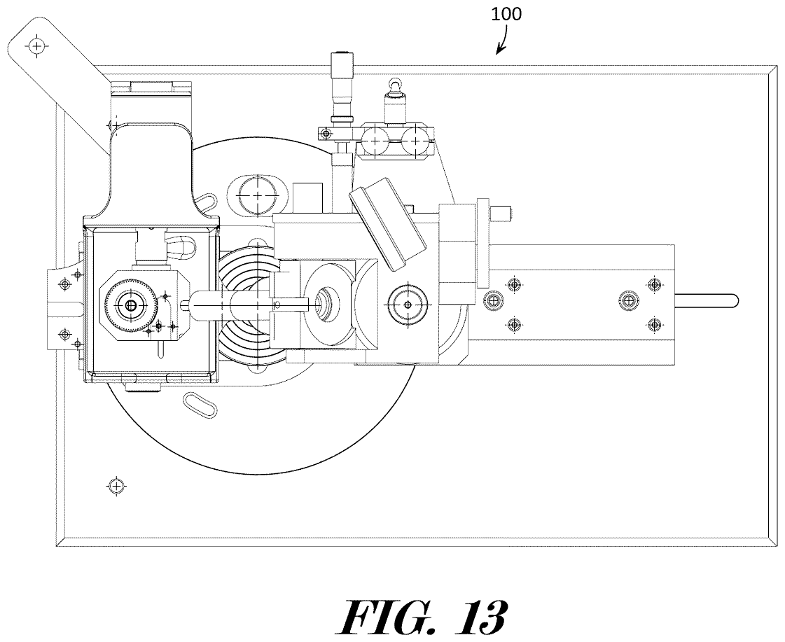

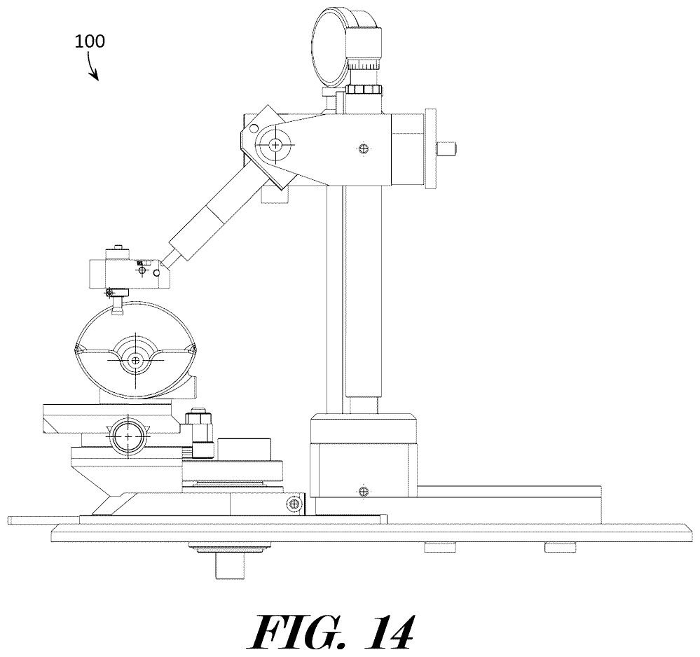

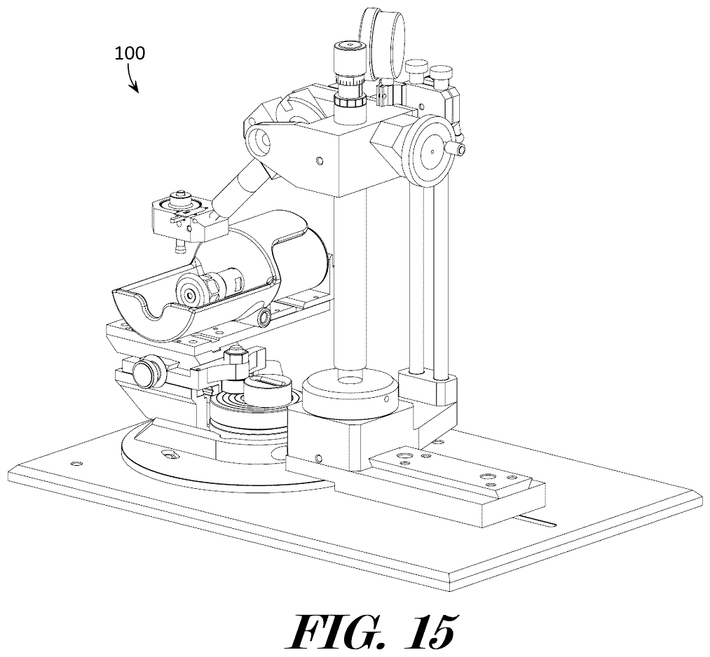

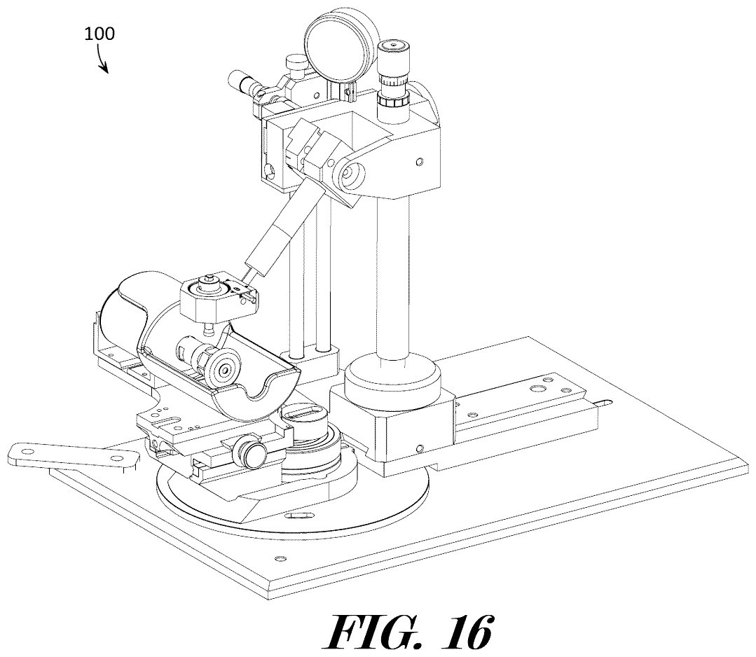

The present invention will now be described by example and through referencing the appended figures representing preferred and alternative embodiments. FIGS. 1-16 illustrate examples of a fancy concave cutting gemstone faceting attachment device (“the device”) 100 according to various embodiments.

In preferred embodiments, the Protractor Base Plate 1 may lay flat on the faceting machine's main base plate and can be affixed to the main base plate of the faceting machine with screws, clamping, adhesive or other means to secure movement on the faceting machine's main plate. The Protractor Base Plate 1 may comprise metal, plastic, wood or other material capable of being engraved, machined and supportive of the components mounted. The Protractor Base Plate 1 preferably may have a 360-degree engraved protractor reading on the top surface outer rim. It is preferably round in shape to support the Protractor Swivel Base Plate 2 and allow precision incremental degree movement on a circumference arc plane.

The Protractor Swivel Base Plate 2 may be movably coupled to the Protractor Base Plate 1 so that the Protractor Swivel Base Plate 2 rides on top of the Protractor Base Plate 1 in a circumference movement, preferably allowing 1/10^{th} degree precision with engraved graduations. The Protractor Swivel Base Plate 2 preferably can rotate 360 degrees around the Rotating Platen 22 to allow maximum axial motion about the Rotating Platen's 22 centerline.

The Oscillation Cam 3 can be manufactured out of metal, plastic or other materials. In preferred embodiments, the Oscillation Cam 3 may be cylindrical in shape with a stadium shaped channel or slot formed into it. The function of the Oscillation Cam 3 is to provide a bearing surface for the Oscillation Cam Follower Bearing 21 to ride on. As the Oscillation cam 3 is rotated by the platen 22, the Oscillation Cam 3 allows linear reciprocating motion to be applied to the Oscillation Cross Slide Base 6, the Oscillation Cross Slide Motor Mount 8, Motor Mount Brackets 10, Motor 11 (preferably an Electric 24 volt DC Motor), Water Catch Basin 12, Motor Collet Chuck 13, and the rotating Cutting Mandrel 14 as an upper assembly by being driven from the primary motor found underneath the faceting machine's main base. The Oscillation Cam 3 may be mounted to the faceting machines Rotating Platen 22 via a screw or other fastener. The Oscillation Cam 3 may be adjusted by loosening the screw (center of the cam) and sliding the Oscillation Cam 3 may along a slot or channel that mates to the Rotating Platen 22 boss.

The Oscillation Platform Base with Liner Bearing Mount 4 are the support columns or structure for the Oscillation Cross Slide Base 6 and upper assembly as noted above. The Oscillation Platform Base 4 contains Oscillation Platform Linear Bearings 7 which allow reciprocating motion axially from centerline of the Rotating Platen 22. The amount of stroke the Oscillation Cross Slide Base 6 and upper assembly can move is controlled by the Oscillation Cam's 3 movement adjusted by a faceting machine operator.

The Oscillation Cross Slide Micrometer Knob 5 preferably may be a knurled or machined grip type knob or other user interface that has incremented measurements around the circumference of the outer edge, allowing fine micrometer type measurement adjustment of the side to side positioning of the Oscillation Cross Slide Motor Mount Plate 8.

The Oscillation Cross Slide Base 6 is the main platform that carries the linear bearings 7, the Oscillation Cross Slide Motor Mount Plate 8, the fine adjusting Oscillation Cross Slide Micrometer Knob 5 assembly and Oscillation Cam Follower Bearing 21. This Oscillation Cross Slide Base 6 plate preferably has a dovetail to mate to a channel of the Oscillation Cross Slide Motor Mount Plate 8 to couple the Oscillation Cross Slide Base 6 and Oscillation Cross Slide Motor Mount Plate 8 together. Another main function of the Oscillation Cross Slide Base 6 is a support structure for the complete motor assembly 10, 11, 12, 13, 14 for the oscillation movement perpendicular to the axis of the Rotating Platen 22.

The Oscillation Platform Linear Bearings 7 are aligned substantially parallel with the Oscillation Platform Base 4 and the Oscillation Cross Slide Base 6 allowing a precision linear motion (reciprocating) for the upper assembly as noted above. The Oscillation Platform Linear Bearings 7 can be a ball bearing, linear rail bearing, roller bearing, etc., having a linear reciprocating action.

The Oscillation Cross Slide Motor Mount 8 plate allows the mounting of a motor 11 to the Oscillation Cross Slide Base 6. The Oscillation Cross Slide Motor Mount Plate 8 allows mounting of the 90 Degree Motor Mount Adaptor Plate 25 to facilitate rotating the motor 11 preferably 90 degrees to the linear motion of the Oscillation Cross Slide Base 6. The dovetail detail on the Oscillation Cross Slide Base 6 allows a perpendicular (side to side) movement of the Oscillation cross slide motor mount plate 8 and motor 11 to the axis of the Rotating Platen 22 allowing offset concave faceting on a stone. The Oscillation Cross Slide Base 6 preferably comprises an engraved graduation to aid in precision movement measurement of the Oscillation Cross Slide Motor Mount Plate 8.

The Oscillation Cross Slide Motor Mount Plate Lock 9 is used to lock the movement or positioning of the Oscillation Cross Slide Motor Mount Plate 8 relative to the Oscillation Cross Slide Base 6. Preferably, the Oscillation Cross Slide Motor Mount Plate Lock 9 may comprise a gibb locking thumbscrew with a small gibb (dovetail locking clamp action) against the dovetail. The Oscillation Cross Slide Motor Mount Plate Lock 9 may be a knurled thumbscrew that rides in the rear of the Oscillation Cross Slide Motor Mount Plate 8.

The 90 Degree Motor Adaptor Plate 25 may be used as an option to mount the motor 11 (preferably an Electric 24 Volt DC Motor 0-7K RPM motor or other type of motor) substantially 90 degrees or perpendicular to the movement of the Oscillation Cross Slide Base 6. The 90 Deg Motor Mount Adaptor Plate 25 also carries the full assembly of the motor components 10, 11, 12, 13, 14. (Components 10, 11, 12, 13, 14, may comprise the motor components assembly.)

The Motor Mount Brackets 10 are to mount the Motor 11 to the Oscillation Cross Slide Motor Mount 8. The Motor Mount Brackets 10 are made to be adjusted forward and aft (preferably with screws, t-slots, fasteners) and can be adjusted for multiple manufactured types of motors. The Motor Mount Brackets 10 are for rigid support of the electric motor 11 mounted on top of the Oscillation Cross Slide Motor Mount Plate 8 and can mount to the optional 90 Degree Motor Adaptor Plate 25. The Motor Mount Brackets 10 can mount the electric motor 11 parallel or perpendicular to the axis of the movement of the Oscillation Cross Slide Base 6 allowing a 90-degree offset of the motor 11 for different angles of faceting.

The Motor 11 (preferably Electric 24 Volt) is the rotary power source for the Cutting Mandrel 14 and can be made with different voltage requirements such as an AC or DC current, different amperage, and different shaft diameters. The Motor 11 preferably may be controlled by a variable speed control wired to the Motor 11 based on the motor's requirements.

Preferably, the device 100 may include a Water Catch Basin 12. Preferably, the Water Catch Basin 12 may be rigid or flexible in construction. The Water Catch Basin 12 is a water catching trough for a water feed tube that is used to lubricate the Mandrel 14 while a stone is being cut. The Water Catch Basin 12 preferably has a provision to allow constant drainage through a tube tapped into the bottom (gravity fed drain) of the basin. The Water Catch Basin 12 preferably may be made of Poly Vinyl Chloride tubing, Acrylic, Phenolic, Acetyl, Delrin, Polycarbonate, or other polymers capable of providing water mitigation and drainage.

The Motor Collet Chuck 13 may comprise a tapered collet clamping design capable of clamping on round shank shaped Cutting Mandrels 14. The Motor Collet Chuck 13 can be tightened with wrenches or by hand by a screw and lock action. The Motor Collet Chuck 13 can be fastened to the Motor 11 by press fit, set screws, threading, or other suitable connection method onto the main motor output shaft.

The Cutting Mandrel 14 can be a variety of marketed round mandrel products made from sintered bronze, polymers, copper, brass, aluminum, plastics and associated material capable of carrying cutting media to facilitate cutting stone. Typically used are diamond powder coated products designed to cut stone. The Cutting Mandrel 14 can come in multiple diameter shanks that will fit into the collets on the Motor Collet Chuck 13.

The Mast Hard Stop Shaft 15 may be mounted to an existing faceting machines gem cutting mast assembly with a screw or other fastener. The Mast Hard Stop Shaft 15 is a mechanical hard point of contact between the Mast Hard Stop Fine Tune Micrometer Head 18, and the Mast Hard Stop Adjustable Locking Block 16. The main faceting machine head rotates axially and in the upright configuration around the mast shaft. This action allows the contact point of the Mast Hard Stop Shaft 15 and the Mast Hard Stop Fine Tune Micrometer Head 18 to make contact, stopping the rotation of the main faceting machine head and preventing over travel axially. This ensures stone alignment for cutting.

The Mast Hard Stop Adjustable Locking Block 16 is the mount for the Mast Stop Fine Tune Micrometer Head 18 and brace to prevent tortional motion as the Mast Hard Stop Shaft 15 makes contact with the Mast Stop Fine Tune Micrometer Head 18. The Mast Hard Stop Adjustable Locking Block 16 is configured to move vertically along the Mast Hard Stop Guide Rods 19 and locks in any place along the guide rods 19. The alignment of the Mast Hard Stop Adjustable Locking Block 16 is controlled by a channel or channels that conform to the Mast Hard Stop Guide Rods 19. The locking action may be through a knurled or levered handle 17 that mounts to the Mast Hard Stop Adjustable Locking Block 16.

The Mast Hard Stop Adjustable Lock Lever 17 may be a hand locking lever or knurled knob that screw locks the two halves of the Mast Hard Stop Adjustable Locking Block 16 tight to the Mast Hard Stop Guide Rods 19 to arrest the position of the Mast Hard Stop Adjustable Locking Block 16 on the Mast Hard Stop Guide Rods 19.

The Mast Hard Stop Fine Tune Micrometer Head 18 may be configured as a simple micrometer head that may be utilized as a fine adjustable high accuracy faceting head stop. The micrometer movement allows fine-tuned radial precision stopping points for the faceting head's rotational movement. This allows proper alignment of the faceting head quill or spindle to the Cutting Mandrel 14 axis of rotation.

The Mast Hard Stop Guide Rods 19 mount into or are otherwise coupled to the Main Mast Support Slide Bar 20. The Mast Hard Stop Guide Rods 19 provide accurate linear movement guidance for the Mast Hard Stop Adjustable Locking Block 16 along the vertical movement of the locking block 16. The Mast Hard Stop Guide Rods 19 preferably may be hardened ground steel, stainless steel, or chromed steel rods suitable for rigidity. The Mast Hard Stop Guide Rods 19 are to be the length of the full movement requirement of the faceting machine's faceting head in the vertical direction.

The Main Mast Support Slide Bar 20 preferably may be a base plate with dovetail cut guide for linear precision movement of the Main Mast Support Slide Bar 20 toward and away from the oscillation platform. The Main Mast Support Slide Bar 20 provides a precision flat platform to mount the existing faceting machine's mast tower assembly. The Main Mast Support Slide Bar 20 also provides rigidity and precision positioning to the Mast Hard Stop Guide Rods 19.

The Oscillation Cam Follower Bearing 21 preferably may be an off the shelf precision roller bearing that rides the Oscillation Cam 3 and provides smooth transmission of the cam oscillations to the oscillation platform 6, 7, 8, 9, 10, 11, 12, 13, 14. (Components 6, 7, 8, 9, 10, 11, 12, 13, 14, comprise the oscillation platform.)

The Rotating Platen 22 is a part of every faceting machine in the marketplace, and may be a basis of the fancy concave cutting gemstone faceting attachment device 100. The Rotating Platen 22 is driven by an electric motor under the faceting machine's main platform base. It can run clockwise and counterclockwise, respectively.

The Main Mast Base with Dovetail Rail 23 provides a precision sliding movement action to the mast assembly. Preferably, the mast assembly slides along the dovetail channel(s) located on the Main Mast Base with Dovetail Rail 23 and can lock with a gibb block located under the Mast Base Locking Screw 24 which may be engaged to a set screw threaded hole machined into the Main Mast Support Slide Bar 20. The setscrew hole on the Main Mast Support Slide Bar 20 can accept thumbscrews, levers, setscrews, or locking knob type devices provided from the marketplace. The Main Mast Base with Dovetail Rail 23 can slide and lock in place along the axis of the dovetail's channel with screws to the main base plate of the main faceting machine. These screws preferably may be held in place with “T nut” brass locking nuts underneath the main faceting machine's base plate. This allows movement of the complete mast assembly with The Main Mast Base with Dovetail Rail 23 to overlap the Protractor Base Plate 1 allowing the complete mast assembly to slide up to the machine's platen 22 and the Protractor Swivel Base Plate 2.

While some exemplary shapes and sizes have been provided for elements of the device 100, it should be understood to one of ordinary skill in the art that any component or element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

What is claimed is:

1. A fancy concave cutting gemstone faceting attachment device for use with a faceting machine having a rotating platen and a main base plate, the device comprising:
a. a Protractor base plate configured to be coupled to the main base plate of the main faceting machine;
b. a protractor swivel base plate movably coupled to the Protractor base plate;
c. an Oscillation cross slide base movably coupled to the protractor swivel base plate so that the Oscillation cross slide base is linearly movable towards and away from the platen;
d. an Oscillation cross slide motor mount plate movably coupled to the Oscillation cross slide base so that it is movable in a direction perpendicular to the linearly movable coupling of the Oscillation cross slide base to the protractor swivel base plate;
e. a motor coupled to the Oscillation cross slide motor mount plate; and
f. a Motor collet chuck coupled to the motor.
